(19) United States
(12) Patent Application Publication
(10) Pub. No.: US 2023/0249298 A1
(43) Pub. Date: Aug. 10, 2023

(54) Receiving Device for Receiving an Object of Any Shape

(71) Applicant: ZF Friedrichshafen AG, Friedrichshafen (DE)

(72) Inventor: Siegbert Stuetzenberger, Wangen (DE)

(21) Appl. No.: 18/165,564

(22) Filed: Feb. 7, 2023

(30) Foreign Application Priority Data
Feb. 8, 2022 (DE) 10 2022 201 272.0

(51) Int. Cl. B23Q 1/03; B23Q 1/50

(52) U.S. Cl. CPC B23Q 1/035; B23Q 1/50

(57) ABSTRACT

A receiving device for receiving an object of any shape includes a horizontally extending base plate with a plurality of threaded bores being defined in the base plate, where the plurality of threaded bores are spaced apart across the base plate. The receiving device further includes a plurality of supports, where each of the plurality of supports extends between a first end and a second end. Each of the plurality of supports is screwed proximate the first end into the plurality of threaded bores such that the second ends of the plurality of supports project vertically upward at a specific height from the base plate such that an object of any shape is placeable in a desired position on the second ends of the plurality of supports.

### CROSS-REFERENCE TO RELATED APPLICATION

The present application is related and has right of priority to German Patent Application No. 10 2022 201 272.0 filed on Feb. 8, 2022, the entirety of which is incorporated by reference for all purposes.

### FIELD OF THE INVENTION

The invention relates generally to a receiving device for receiving an object of any shape, having a horizontally extending base plate, where an object of any shape is placeable in a desired position on ends of a plurality of supports or “support means” which project vertically upward from the base plate.

### BACKGROUND

Receiving devices serve for placement of an object thereon in order to bring said object, together with the receiving device, into an assembly position or disassembly position of the object. In particular examples, the object is a transmission which is to be installed in a vehicle or removed from a vehicle. In such instances, the receiving device is moved into the assembly or disassembly position by a lifting device. If the object has sensitive regions, such as an oil pan made of plastic or a deep-drawn steel oil pan, the object must rest on locations other than the sensitive regions of the object in order to avoid damage. These supports or “support means” must be placed precisely in order to avoid a situation where the object rests with its sensitive regions on the support means.

### SUMMARY OF THE INVENTION

It is the object of the invention to provide a receiving device for receiving an object of any shape of the type mentioned at the outset, where the receiving device is of simple construction, provides precise placement of the supports or “support means,” and enables use with different objects.

According to the invention, a receiving device is provided that includes a base plate in which a plurality of threaded bores is formed, with the plurality of threaded bores being distributed over the base plate, the threaded support means are screwed at their one end into the bores so as to project to specific heights from the base plate.

Since the threaded bores are placed very precisely, the support means are also placed accurately.

Furthermore, the threaded joint enables the support means to be easily removed and replaced by other support means projecting to a different height from the base plate. Additionally, or alternatively, the threaded joint enables support means to be arranged in other threaded bores not previously provided with support means. It is thereby possible to modify the same receiving device such that objects having are able to rest in other desired positions on the support means of the receiving device.

It is particularly simple and inexpensive if the support means are support pins.

In this case, all or some of the support pins have a conical taper or a spherical shape in the opposite end regions thereof from the base plate in order to avoid sharp edges which could cause damage to the object.

All or some of the support pins have a central depression on the opposite end face thereof from the base plate.

The central depression in all or some of the support pins makes it possible for the points of the object which rest on the support pins to be located in regions of screw heads of the object, where the screw heads then project into the depressions, and it is thus not the screw heads, but points of the object which rest on the regions of the support pins which surround the depressions. Therefore, the actual support height of the support pins is not changed by the screw heads.

If all or some of the support pins project with their threads through the threaded bores and have handles at their downwardly projecting free ends for rotating the support pins, then the heights with which such support pins project upward from the base plate are adjustable or re-adjustable. In this arrangement, the support pins have a support plate at their upper ends.

If the support pins have a reduced diameter in their upwardly directed end regions, they are arranged in a region of the base plate which corresponds to the encircling edge of the object in its desired position, and thus the reduced diameter of the support pins points in the direction of the desired position when the object is resting on the receiving device.

It is inexpensive if the support pins are threaded pins.

It is likewise conducive to the pre-alignment of the object to be placed on the receiving device if, arranged in the encircling edge region of the base plate are one or more guide pieces. The guide pieces have an end region facing the encircling edge of the base plate, closer to the base plate, and corresponding to the circumferentially encircling contour of the object in this region. The guide pieces also have an end region directed away or further from the base plate that is inclined outward toward the encircling edge region circumferentially surrounding the base plate.

If mutually opposite through-apertures are formed in the circumferentially encircling edge region of the base plate, a lashing strap is pulled through the apertures and around the object to secure the object in its desired position during its movement into the assembly position or out of the assembly position.

If the base plate is pivotable out of its horizontal position through a pivoting angle by an adjusting device, then, when the lifting device with the receiving device and the object lying on it is being raised into the assembly position or lowered into the disassembly position, the receiving device is pivotable into a position which allows better movement in terms of space.

### BRIEF DESCRIPTION OF THE DRAWINGS

An exemplary embodiment of the invention is illustrated in the drawing and is described below in greater detail. In the drawing:

FIG. 1 shows a perspective front view of a receiving device, particularly illustrating a first arrangement of support pins;

FIG. 2 shows a plan, top-down view of the receiving device according to FIG. 1;

FIG. 3 shows a perspective view of the receiving device according to FIG. 1;

FIG. 4 shows another perspective front view of the receiving device according to FIG. 1, particularly illustrating a second arrangement of support pins;

FIG. 5 shows a plan, top-down view of the receiving device according to FIG. 4;

FIG. 6 shows a perspective view of the receiving device according to FIG. 4;

FIG. 7 shows a further perspective front view of the receiving device according to FIG. 1, particularly illustrating a third arrangement of support pins;

FIG. 8 shows a plan, top-down view of the receiving device according to FIG. 7; and

FIG. 9 shows a perspective view of the receiving device according to FIG. 7.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

The receiving device illustrated serves to enable a transmission (not illustrated) to be placed onto it from above in order to raise the transmission from below into an assembly position in a motor vehicle or in order to lower a transmission from its assembly position during its removal. For this purpose, the receiving device is raised or lowered by a lifting device (not illustrated), in particular a hydraulic lifting device.

As shown in the figures, the receiving device has an approximately rectangular base plate 1 in which a plurality of threaded bores 2 is formed or defined, with the plurality of threaded bores 2 being distributed over the surface of the base plate 1.

Support pins 3, 3′, 3″, 3′″, 3″″ are screwed into the threaded bores 2 with their threaded ends in such a way that the second, upper ends of the support pins project upward from the base plate 1 to specific heights in each case. At their upper end, some of the support pins 3 have a support surface over the entire end face thereof.

Others of the support pins 3′ have conical tapers 4 at their second ends, where the second ends are directed away from the base plate 1.

Yet others of the support pins 3″ are provided with central depressions 5 of round cross section at their second ends directed away from the base plate 1, where the depressions 5 are base bores of limited depth.

Furthermore, in the edge region of the base plate, two support pins 3′″ are arranged approximately diagonally opposite one another in corner regions of the base plate 1, where said support pins have a reduced diameter at the ends 6 thereof which are directed away from the base plate 1.

The support pins 3′″ are threaded pins and project downward through the base plate 1. Arranged at the downwardly projecting ends of the support pins 3′″ are handles 7, by which an operator rotates the support pins 3′″ and thus adjust the height to which the support pins 3′″ project upward from the base plate 1.

In order to be able to fix an adjusted height of the support pins 3′″, a lock nut 8 is screwed onto the thread of the support pins 3′″ until it rests against the base plate 1.

Arranged in a further corner region of the base plate 1 is a further support pin 3″″, as a threaded pin, which likewise projects downward through the base plate 1 and is provided at its lower end with a handle 7′, by which an operator rotates the holding pin 3″″ and thus adjust the height to which the bearing pin 3″″ projects upward from the base plate 1.

In order to be able to fix an adjusted height of the support pin 3″″, a lock nut 8 is screwed onto the thread of the support pin 3″″ until it rests against the base plate 1.

The support pin 3″″ has a support plate 9 at its upper end.

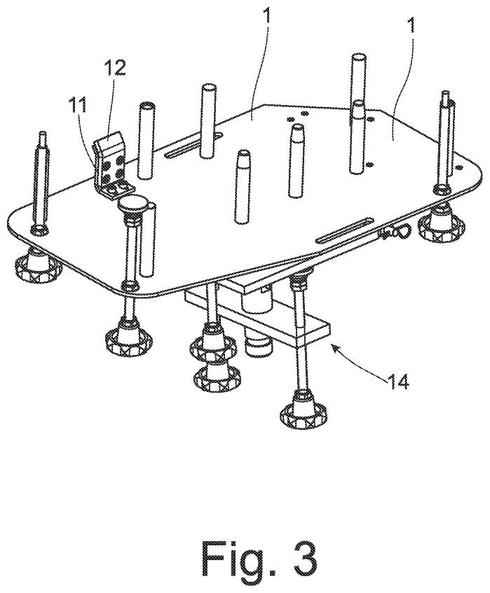

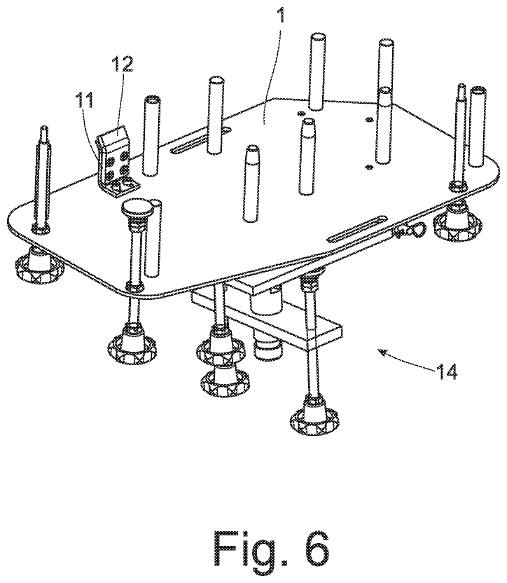

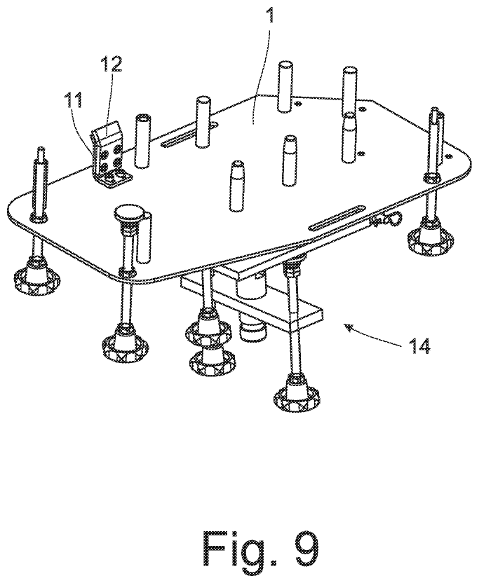

A guide piece 10 is arranged in the encircling edge or perimeter region of the base plate 1. As particularly shown in FIGS. 3, 6, and 9, the region 11 of the guide piece 10 which is closer to the base plate 1 projects vertically upward and then merges into a region 12 which is inclined outward.

As particularly shown in FIGS. 2, 5, and 8, two mutually opposite apertures 13 are elongate through-holes formed on the mutually opposite longitudinal sides of the base plate 1.

Through holes 13, it is possible to pull a lashing strap (not illustrated), which surrounds a transmission resting on the receiving device and thus secures the transmission in its position on the receiving device.

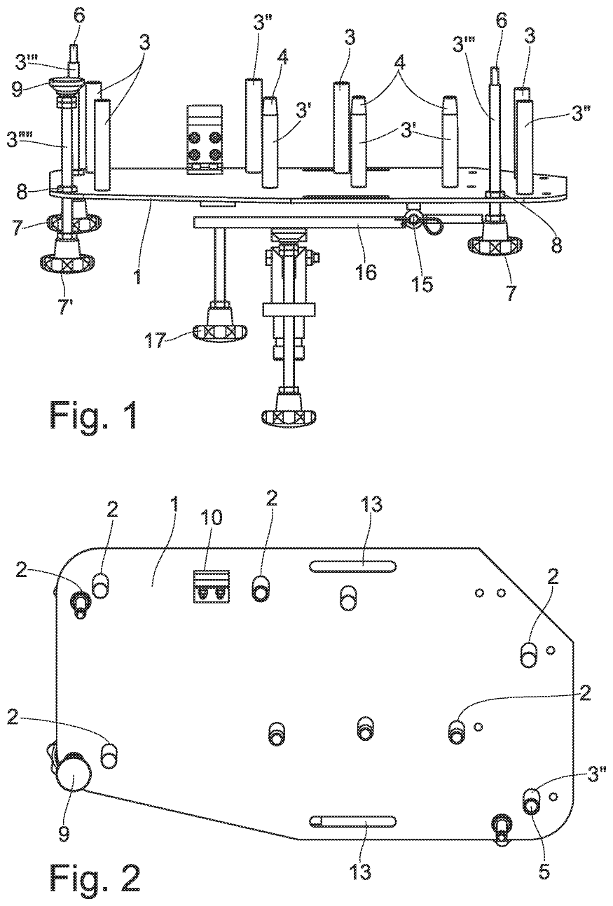

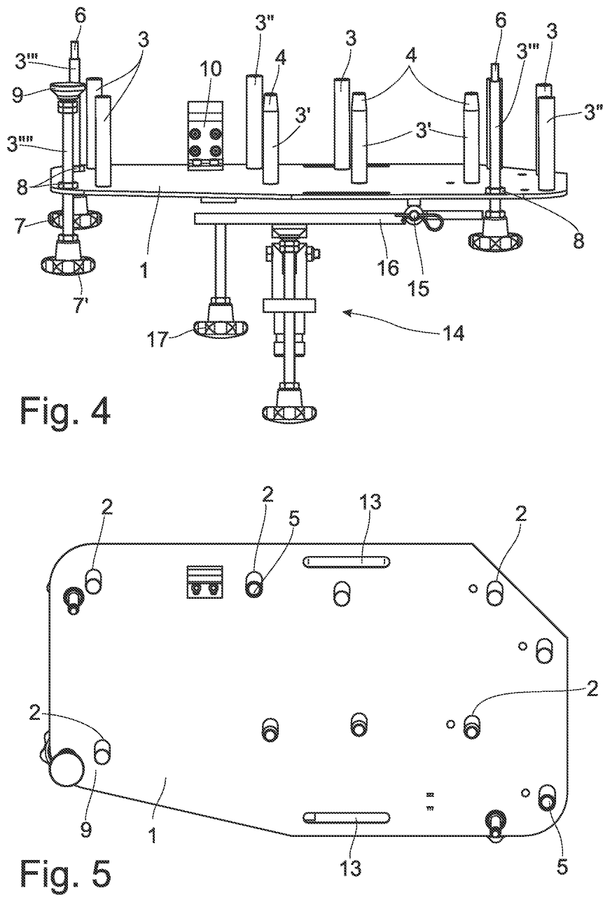

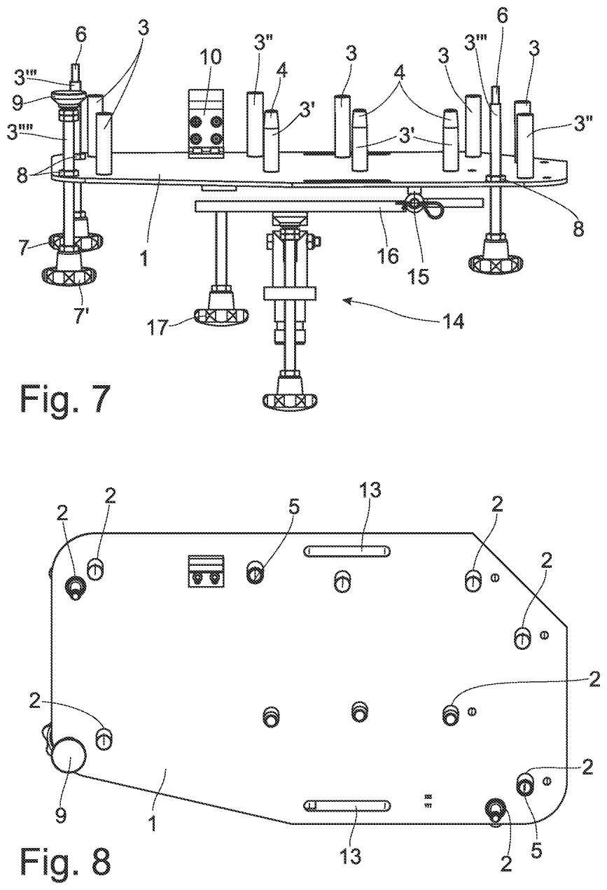

As shown in FIGS. 1, 3, 4, 6, 7, and 9, arranged below the base plate 1 is an adjusting device 14, by which the base plate 1 is pivotable out of a horizontal position into a position inclined by a pivoting angle.

The adjusting device 14 has a pivot lever 16, which is articulated in its one end region on the underside of the base plate 1 to pivot about a pivot axis 15 parallel to the base plate 1.

A handle 17 is arranged on the pivot lever 16 at the end region opposite the pivot axis 15 for pivoting the pivot lever 16 by, for example, 6°, about the pivot axis 15.

If a transmission with an oil sump is placed on the underside of the receiving device, only support pins 3, 3′, 3″, 3′″, 3″″ are arranged at locations of the base plate 1 at which the support pins 3, 3′, 3″, 3′″, 3″″ rest against regions of the transmission housing. In particular, the support pins 3′ make contact in the region of the oil sump since they cannot damage the latter owing to their conical tapers 4.

In the case of the support pins 3″, screw heads present on the transmission enter the depressions 5 in the support pins 3″, resulting in correct support of the transmission on the end of the support pins 3″.

As the transmission is placed on the receiving device, a pre-alignment takes place on the guide piece 10, and correct final alignment of the transmission takes place on the reduced ends 6 of the support pins 3′″, ensuring that the transmission rests in the correct desired position on the support pins 3, 3′, 3″, 3″″.

In order to then hold the transmission in its correct position as the receiving device provided with the transmission is raised into the assembly position of the motor vehicle, a lashing strap which surrounds the transmission is pulled through the apertures 13 and tightened.

If the space conditions on the motor vehicle require it, the receiving device is pivotable by the adjusting device 14 before it is raised and is thus raised more reliably into the assembly position in order to be pivoted back into its desired position and installed on the motor vehicle.

Since the support pins 3, 3′, 3″, 3′″ are arrangeable in the three arrangements shown in FIGS. 1-3, FIGS. 4-6, and FIGS. 7-9, respectively, with different heights, transmissions with differently structured undersides are processable with otherwise the same receiving device. All that is necessary is to arrange support pins 3, 3′, 3″, 3′″ on the base plate 1 which correspond in their position and their height to the underside of the respective transmission to be processed.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE SIGNS

1 base plate
2 threaded holes
3 support pin
3′ support pin
3″ support pin
3′″ support pin
3″″ support pin
4 conical tapers
5 depressions
6 reduced ends
7 handle
7′ handle
8 lock nut
9 support plate
10 guide piece
11 region
12 region
13 apertures
14 adjusting device
15 pivot axis
16 pivot lever
17 handle
31 first drive flange

1-11: (canceled)

12. A receiving device for receiving an object of any shape, comprising:
a horizontally extending base plate (1), a plurality of threaded bores (2) being defined in the base plate (1), the plurality of threaded bores (2) being spaced apart across the base plate (1); and
a plurality of supports (3, 3′, 3″, 3′″, 3″″), each of the plurality of supports extending between a first end and a second end, each of the plurality of supports being screwed proximate the first end into the plurality of threaded bores (2) such that the second ends of the plurality of supports project vertically upward at a specific height from the base plate (1), an object of any shape being placeable in a desired position on the second ends of the plurality of supports.

13. The receiving device of claim 12, wherein the plurality of supports are a plurality of support pins (3, 3′, 3″, 3′″, 3″″).

14. The receiving device of claim 13, wherein at least one support pin (3′) of the plurality of support pins (3, 3′, 3″, 3′″, 3″″) has a conical taper (4) or a spherical shape proximate the second end.

15. The receiving device of claim 13, wherein at least one support pin (3″) of the plurality of support pins (3, 3′, 3″, 3′″, 3″″) has a central depression (5) proximate the second end.

16. The receiving device of claim 13, wherein the first end of at least one support pin (3′″, 3″″) of the plurality of support pins (3, 3′, 3″, 3′″, 3″″) projects through a respective one of the plurality of threaded bores (2) such that a thread proximate the first end of the at least one support pin (3′″, 3″″) extends from an opposite side of the base plate (1) from the second end of the at least one support pin (3′″, 3″″),
the receiving device further comprising at least one handle (7, 7′), each of the at least one handle (7, 7′) being proximate the first end of a respective one of the at least one support pin (3′″, 3″″) for rotating the respective one of the at least one support pin (3′″, 3″″).

17. The receiving device of claim 16, further comprising a support plate (9) at the second end of the at least one support pin (3″″) of the plurality of support pins (3, 3′, 3″, 3′″, 3″″).

18. The receiving device of claim 16, wherein the at least one support pin (3′″) of the plurality of support pins (3, 3′, 3″, 3′″, 3″″) has a reduced diameter at an upwardly directed end region (6) proximate the second end.

19. The receiving device of claim 16, wherein each of the at least one support pin (3′″, 3″″) is a threaded pin.

20. The receiving device of claim 12, further comprising one or more guide pieces (10) at an encircling edge region of the base plate (1), each of the one or more guide pieces (10) having a first end region (11) and a second end region (12), the first end region (11) facing away from the encircling edge region of the base plate (1) and being positioned closer to the base plate (1) than the second end region (12), the first end region (11) corresponding to part of a circumferentially encircling contour of an object of any shape placeable on the second ends of the plurality of supports, the second end region (12) being inclined outwardly from the first end region (11) away from the base plate (1) and toward the encircling edge region of the base plate (1).

21. The receiving device of claim 20, wherein a first through-aperture (13) and a second through-aperture (13) are formed in the base plate (1) at opposite sides of the base plate (1) proximate the encircling edge region of the base plate (1).

22. The receiving device of claim 12, wherein the base plate (1) is pivotable through a pivoting angle from a horizontally extending position by an adjusting device (14).
